(19) United States
(12) Patent Application Publication
(10) Pub. No.: US 2001/0032102 A1
(43) Pub. Date: Oct. 18, 2001

(54) Psychiatric information systems, methods and computer program products that capture psychiatric information as discrete data elements

(76) Inventor: Kenneth Ronald Gersing, Durham, NC (US)

Correspondence Address: MYERS BIGEL SIBLEY & SAJOVEC, PO BOX 37428, RALEIGH, NC, 27627, US

(21) Appl. No.: 09/803,492

(22) Filed: Mar. 9, 2001

Related U.S. Application Data
(60) Provisional application No. 60/189,508, filed on Mar. 15, 2000.

(51) Int. Cl. G06F 17/60

(52) U.S. Cl. 705/2

(57) ABSTRACT

Psychiatric information systems, methods and computer program products include an emergency room module, an outpatient module and a scales module. The emergency room module is configured to capture psychiatric information concerning emergency room visits by psychiatric patients, including psychiatric assessments, as discrete data elements. The outpatient module is configured to capture psychiatric information concerning outpatient visits by psychiatric patients, including psychiatric assessments, as discrete data elements. The scales module is configured to capture direct data entry of psychiatric scales as discrete data elements. A database repository also is included that is configured to store the discrete data elements that are captured by the emergency room module, the outpatient module and the scales module. The emergency room module, the outpatient module and the scales module are configured to capture the discrete data elements using at least one dialogue box. A dialogue box is a computer display window that contains a form or checklist to be filled out, and can include text boxes, regular list boxes, drop-down list boxes, check boxes, and/or sliding controls. Accordingly, traditionally text-based psychiatric information may be captured as discrete data elements, using dialogue boxes, to thereby allow the discrete data elements to be stored, queried, mined and/or otherwise used as discrete data elements of a database.

### CROSS-REFERENCE TO PROVISIONAL APPLICATION

This application claims the benefit of Provisional Application Ser. No. 60/189,508, filed Mar. 15, 2000, by the present inventor, the disclosure of which is hereby incorporated herein by reference in its entirety as if set forth fully herein.

### FIELD OF THE INVENTION

This invention relates to information processing systems, methods and computer program products, and more particularly to medical information processing systems, methods and computer program products.

### BACKGROUND OF THE INVENTION

Medical information processing systems, methods and computer program products are widely used in hospitals, clinics, physicians' offices, research studies and/or other medical environments, to capture medical information. The medical information that is captured can be stored in one or more databases, and can be manipulated as database elements.

However, in sharp contrast to other fields of medicine, psychiatry generally is a text-based practice, wherein patient histories, diagnoses, assessments and treatment plans are described using free-form text. See, for example, the publication entitled Databases for Clinical Psychiatry by Guze, M.D. et al., M.D. Computing, Vol. 13, No. 3, 1996, pp. 210-215, the disclosure of which is incorporated herein by reference.

### SUMMARY OF THE INVENTION

Embodiments of the present invention provide psychiatric information systems, methods and computer program products that include an emergency room module, an outpatient module and a scales module. The emergency room module is configured to capture psychiatric information concerning emergency room visits by psychiatric patients, including psychiatric assessments, as discrete data elements. The outpatient module is configured to capture psychiatric information concerning outpatient visits by psychiatric patients, including psychiatrist assessments, as discrete data elements. The scales module is configured to capture direct data entry of psychiatric scales as discrete data elements. A database repository also is included that is configured to store the discrete data elements that are captured by the emergency room module, the outpatient module and the scales module.

Psychiatry has a rich tradition of clinical information being recorded into a descriptive free-text prose. The nuances of a patient's history and the description of a patient's life may be recorded in the richness of the author's writings. Embodiments of the present invention can facilitate this rich and important aspect of the psychiatry, while simultaneously collecting discrete data elements, like medication side effects, lab values, medical history and/or allergies that psychiatrists may desire to know in order to deliver quality care. In fact, embodiments of the invention can collect discrete data elements on every aspect of a patient's medical record, from social and developmental history to physical exams.

Psychiatric information systems, methods and computer program products according to other embodiments of the invention also include a query module that is configured to initiate queries of the discrete data elements that are captured by the emergency room module, the outpatient module and the scales module that are stored in the database repository. Some embodiments also include a data mining module that is configured to perform data mining of the discrete data elements that are captured by the emergency room module, the outpatient module and the scales module that are stored in the database repository, to produce data mining results that are free of personal identifying information on the psychiatric patients. Secure, deidentified results therefore may be provided.

Still other embodiments include a research module that is configured to capture psychiatric information concerning individuals who are participating in a psychiatric research study, as discrete data elements. In these embodiments, the database repository is further configured to store the discrete data elements that are captured by the research model.

Still other embodiments include a billing module that is configured to generate medical bills from the discrete data elements that are captured by the emergency room module, the outpatient module and the scales module that are stored in the database repository. In some embodiments, the billing module is further configured to complete government and insurance forms, preferably automatically, from the discrete data elements that are captured by the emergency room module, the outpatient module and the scales module that are stored in the database repository.

In still other embodiments, a treatment plan module is configured to capture a treatment plan for individuals that are undergoing psychiatric treatment, as discrete data elements. In these embodiments, the database repository is further configured to store the discrete data elements that are captured by the treatment plan module.

In still other embodiments of the invention, the emergency room module, the outpatient module and the scales module are configured to capture the discrete data elements using at least one dialogue box. As is well known to those having skill in the art, a dialogue box is a computer display window that contains a form or checklist to be filled out, and can include text boxes, regular list boxes, drop-down list boxes, check boxes, and/or sliding controls.

Other psychiatric information systems, methods and computer program products according to embodiments of the present invention include a psychiatric diagnosis dialogue box, a past psychiatric history dialogue box, a social history dialogue box and a mental status exam dialogue box. The psychiatric diagnosis dialogue box is configured to capture psychiatric diagnoses of psychiatric patients as discrete data elements. The past psychiatric history dialogue box is configured to capture past psychiatric histories of psychiatric patients as discrete data elements. The social history dialogue box is configured to capture social histories of psychiatric patients as discrete data elements. The mental status exam dialogue box is configured to capture results of standardized mental status tests of psychiatric patients as discrete data elements. These embodiments also include a database repository that is configured to store the discrete data elements that are captured by the psychiatric diagnosis dialogue box, the past psychiatric history dialogue box, the social history dialogue box and the mental status exam dialogue box.

Still other embodiments include a medical history dialogue box, a substance history dialogue box, a medications dialogue box, an allergies dialogue box, a developmental dialogue box, a family history dialogue box, a physical exam dialogue box, and/or a labs/imaging dialogue box. The medical history dialogue box is configured to capture non-psychiatric medical histories of psychiatric patients as discrete data elements. The substance history dialogue box is configured to capture histories of substance use by psychiatric patients as discrete data elements. The medications dialogue box is configured to capture information concerning medications used by psychiatric patients as discrete data elements. The allergies dialogue box is configured to capture information concerning allergies of psychiatric patients as discrete data elements. The developmental dialogue box is configured to capture information concerning stages of development of psychiatric patients as discrete data elements. The family history dialogue box is configured to capture information concerning family histories of psychiatric patients as discrete data elements. The physical exam dialogue box is configured to capture information concerning physical exams of psychiatric patients as discrete data elements. Finally, the labs/imaging dialogue box is configured to capture results of laboratory tests and medical imaging tests of psychiatric patients as discrete data elements. The database repository is further configured to store the discrete elements that are captured by the above-described dialogue boxes.

In yet other embodiments, a query module may be included to initiate queries of the discrete data elements that are captured by the psychiatric diagnosis dialogue box, the past psychiatric diagnosis dialogue box, the social history dialogue box and the mental status exam dialogue box that are stored in the database repository. In some embodiments, a data mining module is provided, that is configured to perform data mining of the discrete data elements, to produce data mining results that are free of personal identifying information on the psychiatric patients.

In still other embodiments, a billing module is provided that is configured to generate medical bills from the discrete data elements, and may be further configured to complete government and insurance forms from the discrete data elements. An assessment plan module also may be provided that is configured to generate an assessment plan for individuals that are undergoing psychiatric treatment, from the discrete elements that are stored in the database repository.

Still other psychiatric information systems, methods and computer program products according to embodiments of the invention include a psychiatric information module that is configured to capture psychiatric information concerning psychiatric patients, including psychiatric assessments, as discrete data elements. A database repository is configured to store the discrete data elements that are captured by the psychiatric information module. In some embodiments, a non-psychiatric medical information module also is provided that is configured to capture non-psychiatric medical information concerning psychiatric patients as discrete data elements. In these embodiments, the database repository also may be configured to store the discrete data elements that are captured by the non-psychiatric medical information module. A query module, a data mining module and a billing module also may be provided, as was described above.

Embodiments of the present invention can manage a psychiatric emergency room by storing information concerning an emergency room psychiatric patient, including results of psychiatric tests and non-psychiatric medical tests, in a database. A report is displayed of the information concerning the emergency room psychiatric patient, for review by a psychiatrist. A selection of whether to commit the psychiatric patient or to treat the psychiatric patient on an outpatient basis is accepted, preferably from a psychiatrist. Forms automatically are generated for committing the psychiatric patient or for treating the psychiatric patient on an outpatient basis in response to the selection. In some embodiments, hospital admittance forms are automatically generated in response to the selection to commit the psychiatric patient, and outpatient appointment forms automatically generated in response to the selection to treat the psychiatric patient on an outpatient basis.

In other embodiments, treatment of psychiatric patients is managed by storing information concerning symptoms, medication, psychiatric tests, psychiatric history and medical history of a psychiatric patient in a database. At least some of the stored information is displayed, preferably for psychiatrist review. A treatment recommendation for the psychiatric patient is accepted in response to the display. The treatment recommendation is stored in a database. A treatment plan for the psychiatric patient is automatically generated from the stored information and from the stored treatment recommendation.

Yet other embodiments provide for billing for psychiatric treatment. In particular, a diagnosis of a psychiatric patient is stored in a database. Identifications of providers of psychiatric services are stored in a database. A bill is automatically generated for psychiatric treatment of the psychiatric patient from the diagnosis that is stored and the identifications that are stored.

Accordingly, traditionally text-based psychiatric information may be captured as data elements, using dialogue boxes, to thereby allow the discrete data elements to be stored, queried, mined and/or otherwise used as discrete data elements of a database. Moreover, psychiatric information systems, methods and computer program products may be integrated with medical information systems, methods and computer program products and may be used to manage psychiatric care.

### BRIEF DESCRIPTION OF THE DRAWINGS

FIG. 1 is a block diagram of psychiatric information systems, methods and computer program products according to embodiments of the present invention.

FIGS. 2A-2C, which when placed together as indicated form FIG. 2, illustrate other psychiatric information systems, methods and computer program products according to other embodiments of the invention.

FIG. 3 is a flowchart illustrating the generation of reports, forms and other documentation for a psychiatric emergency room according to embodiments of the present invention.

FIG. 4 is a flowchart of psychiatrist and database interaction to produce a treatment plan for a psychiatric patient according to embodiments of the present invention.

FIG. 5 is a flowchart of interactions among psychiatrists, other personnel and databases to produce billings for psychiatric treatment according to embodiments of the present invention.

### DETAILED DESCRIPTION OF PREFERRED EMBODIMENTS

The present invention will be described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagrams and/or flowchart block or blocks.

The computer program instructions may also be loaded onto a computer or other programmable data processing apparatus to cause a series of operational steps to be performed on the computer or other programmable apparatus to produce a computer implemented method such that the instructions which execute on the computer or other programmable apparatus provide steps for implementing the functions specified in the block diagrams and/or flowchart block or blocks.

It should also be noted that in some alternative implementations, the functions noted in the blocks may occur out of the order noted in the flowcharts. For example, two blocks shown in succession may in fact be executed substantially concurrently or the blocks may sometimes be executed in the reverse order, depending upon the functionality involved.

The present invention may be embodied in a data processing system that can function in multiple arenas and platforms, including client/server, standalone, briefcase and thin-client. This multi-platform model can facilitate distributed data collection in psychiatric clinical settings, with data processing and analysis performed through a central data repository.

Accordingly, a data processing system may be configured with computational, storage and control program resources for capturing psychiatric information as discrete data elements, in accordance with embodiments of the present invention. Thus, the data processing system may be contained in one or more enterprise, personal and/or pervasive computing devices, which may communicate over a network that may be a wired and/or wireless, public and/or private, local and/or wide area network such as the World Wide Web and/or a sneaker network using portable media. Moreover, when integrated into a single computing device, communication may take place via an Application Program Interface (API).

Embodiments of a psychiatric information processing system may include input device(s), such as a keyboard or keypad, a display, and a memory that communicate with one or more processors. The psychiatric information processing system may further include a storage system, a speaker, and one or more input/output (I/O) data port(s) that also communicate with the processor(s). The storage system may include solid state memory such as Dynamic Random Access Memory (DRAM) and/or Static RAM (SRAM), removable and/or fixed media, such as floppy disks, ZIP drives, hard disks, or the like, as well as virtual storage, such as a RAMDISK. The I/O data port(s) may be used to transfer information between the psychiatric information processing system and another computer system or a network (e.g., the Internet). These components may be conventional components such as those used in many conventional computing devices, which may be configured to operate as described herein.

The memory may include an operating system to manage the psychiatric information processing system resources and one or more application programs including one or more application programs for capturing psychiatric information as discrete data elements, according to embodiments of the present invention.

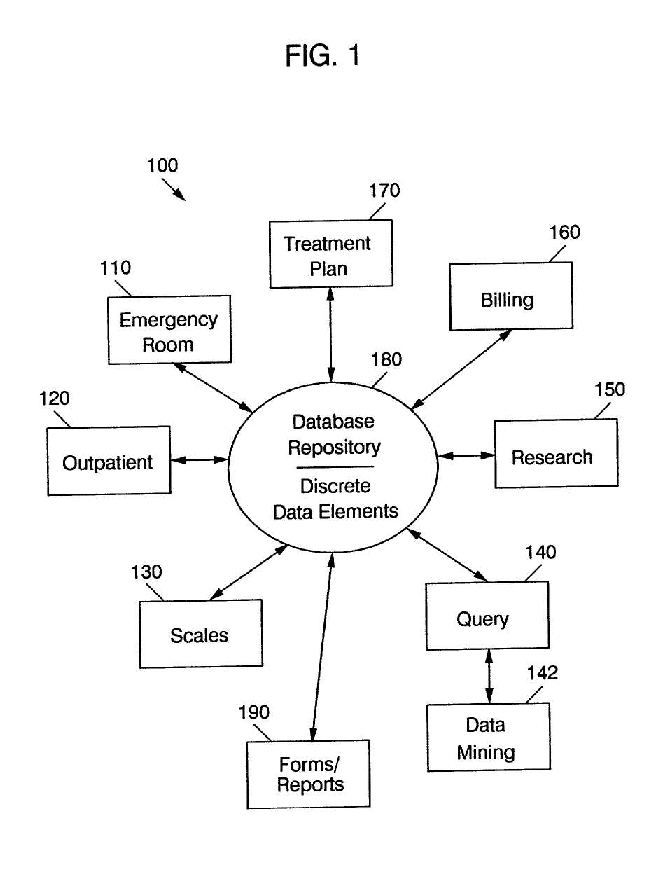

Referring now to FIG. 1, psychiatric information systems, methods and computer program products according to embodiments of the present invention are illustrated. It will be understood that the term “psychiatrist” is used herein as a generic term for a provider of psychiatric care, and can include, for example, psychologists, social workers, therapists, etc. As shown in FIG. 1, these psychiatric information systems, methods and computer program products 100 are organized into several interactive modules.

An emergency room module 110 is configured to capture psychiatric information concerning emergency room visits by psychiatric patients, including psychiatric assessments, as discrete elements. The emergency room module 110 can operate seven days a week, twenty-four hours a day, to help emergency room physicians accurately and efficiently assess and record all emergency room visits as they come in.

An outpatient module 120 is configured to capture psychiatric information concerning outpatient visits by psychiatric patients, including psychiatric assessments, as discrete data elements. For example, the outpatient module 120 can handle electric records in an affective disorders clinic.

The scales module 130 is configured to capture direct data entry of psychiatric scales as discrete data elements. For example, psychiatric scales, such as the Montgomery-Åsberg Depression Rating Scale (MADRS), Hamilton Depression Scale, Clinical Global Impression (CGI), Mini-Mental Status Examination, etc., can be captured for direct data entry. The scales can be chosen from a large pick-list of choices, can be administered, and can be viewed in a graphical format within the psychiatric lab. The scales can be entered by a patient and/or a psychiatrist.

A research module 150 is configured to capture psychiatric information concerning individuals who are participating in a psychiatric research study, as discrete data elements. For example, the research module 150 may be used as a centralized data collection system in a National Institute of Health (NIH) study for depression in the elderly.

A treatment plan module 170 is configured to capture a treatment plan for individuals who are undergoing psychiatric treatment, as discrete data elements. Thus, the treatment plan module 170 can create a bio/psycho/social treatment plan that measures a patient's functionality, and can be used as a guideline to future treatment, for referrals and/or for insurance recertification.

Still referring to FIG. 1, a database repository 180 also is included that is configured to store the discrete data elements that are captured by the emergency room module 110, the outpatient module 120, the scales module 130, the research module 150 and/or the treatment plan module 170. A query module 140 is configured to initiate queries of the discrete data elements that are captured by the other modules and that are stored in the database repository 180. A data mining module 142 also may be used to mine the clinical data repository 180. The data mining module 142 may be coupled to the query module 140, as shown, or may be independent thereof. Examples of data queries include clinical queries of treatment effectiveness or management queries for utilization review.

Data elements that are stored in the database repository 180 are accessible to all investigators with access privileges through the query module 140. The query module 140 can contain a user-based query engine that allows investigators to remotely create their own queries and perform data analysis using OnLine Analytical Processing (OLAP). Investigators also have the option of downloading their query results into a local database, such as Microsoft Access 2000, or a statistical program for further processing. Although data is accessible remotely, it remains secure and unaltered on the main server. Confidentiality is maintained by stripping all patient-identifying data elements prior to query results.

Finally, a billing module 160 is configured to generate medical bills from the discrete data elements that are stored in the database repository 180. A forms/reports module 190 can be used to complete government, insurance and/or other forms, preferably automatically, from the discrete data elements that are stored in the database repository. The billing module 160 and the forms/reports module 190 can be used for electronic filing for the psychiatric outpatient clinics and to record data for utilization review.

The discrete data elements that are collected by the emergency room module 110, the outpatient module 120, the scales module 130, the research module 150, and the treatment plan module 170 can offer a unique set of advantages over conventional free text. Data elements can be manipulated, queried and inserted. They can be used for research, to populate forms, for regulatory requirements and/or for utilization review. These are all important aspects of a regulated health care industry, but often are at cross-purposes in delivering efficient, sensitive care to psychiatric patients. Embodiments of the present invention can collect these elements, store them in the database repository 180, and automatically and seamlessly embed them within an electronic record.

In the past, research generally has set up parallel and redundant systems to collect data elements by gathering information in standardized forms, which were later double-entered by hand and then rechecked. In sharp contrast, embodiments of the present invention as shown in FIG. 1 can eliminate redundancy by combining research and clinical care in the same process/system. Data accuracy also may be increased by having the information directly entered by either patients or staff, to thereby reduce and preferably eliminate data entry errors, while at the same time allowing costs to be lowered.

Additional description of embodiments of the scales module 130 now will be provided. The scales module 130 can provide an indirect data entry system from patients. This data can be collected using reliable and valid psychiatric scales like the Carroll Depression Scale, for example using an optical scan mark sense form. For the patient's self diagnosis, the forms can be automatically preprinted with the patient's name and a unique identifier. The patient then completes the scale, which is then placed into a continuous feeding optical scanner or other input device. The data then is automatically processed and stored in the database repository 180.

The scales function 130 also may be extended to provide a Windows-based, real time data collection engine that can provide Continuous Quality Improvement (CQI) to the practice of psychiatry. By redefining quality medical care from service delivery and documentation to outcome-based treatment and intervention, the practice of psychiatry can be redirected to an approach focused on clinical effectiveness. Quantifying quality and efficiency with CQI can provide enormous advantages, such as lower cost, increased efficiency and/or improved clinical care. Thus, by using the scales module 130 for patient and/or psychiatrist entry at various points in time, the delivery, cost and effectiveness of psychiatric care of a patient can be monitored over time. The query module and/or data mining module 142 also can be used to monitor progress for large groups of patients.

Additional details of the forms/reports module 190 now will be provided. The data that was obtained from the emergency room, outpatient, scales and treatment plan modules can be used by the forms/reports module 190 to provide a graphical report that can be presented like a traditional medical lab. For example, in a medical lab, an internist concerned about renal failure in a patient might order a creatinine, and compare the results to other values over time. In the medical example, the trend of a high creatinine distinguishes chronic renal insufficiency from acute renal failure. In the forms/reports module 190 for psychiatric data, psychiatric data is presented in a usable format, such as a bar chart or line graph that can be viewed or printed by the clinician in the office. This format can help the clinician detect the reoccurrence of a psychiatric illness, such as the symptoms of depression or anxiety, enabling an early intervention and treatment. Moreover, a clinical summary may be created that combines the information described above with other clinical data, including a medical and psychiatric problem list, an adverse reactions and allergies list, a present medications list and most recent laboratory values. The clinical summary may be used to provide a one-page snapshot of patient information for use by clinicians.

Additional description of the research module 150 now will be provided. Psychiatry has a rich tradition of clinical information being recorded into a descriptive free-text prose. The nuances of a patient's history and the description of a patient's life may be recorded in the richness of the author's writings. Embodiments of the present invention can facilitate this rich and important aspect of the psychiatry, while simultaneously collecting discrete data elements, like medication side effects, lab values, medical history and/or allergies that psychiatrists may desire to know in order to deliver quality care. In fact, embodiments of the invention can collect discrete data elements on every aspect of a patient's medical record, from social and developmental history to physical exams.

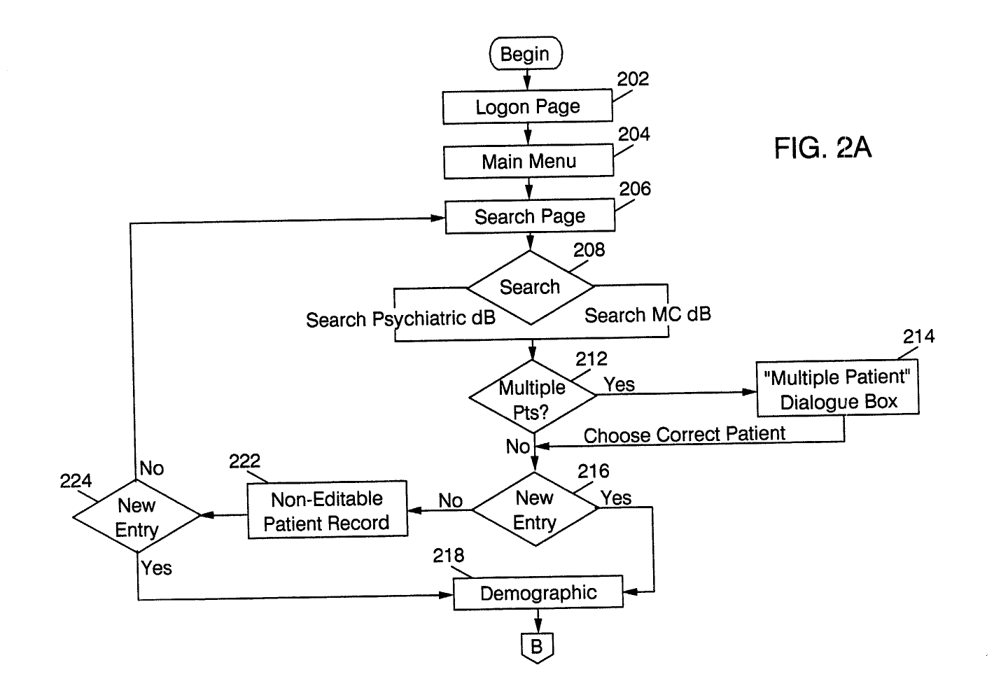

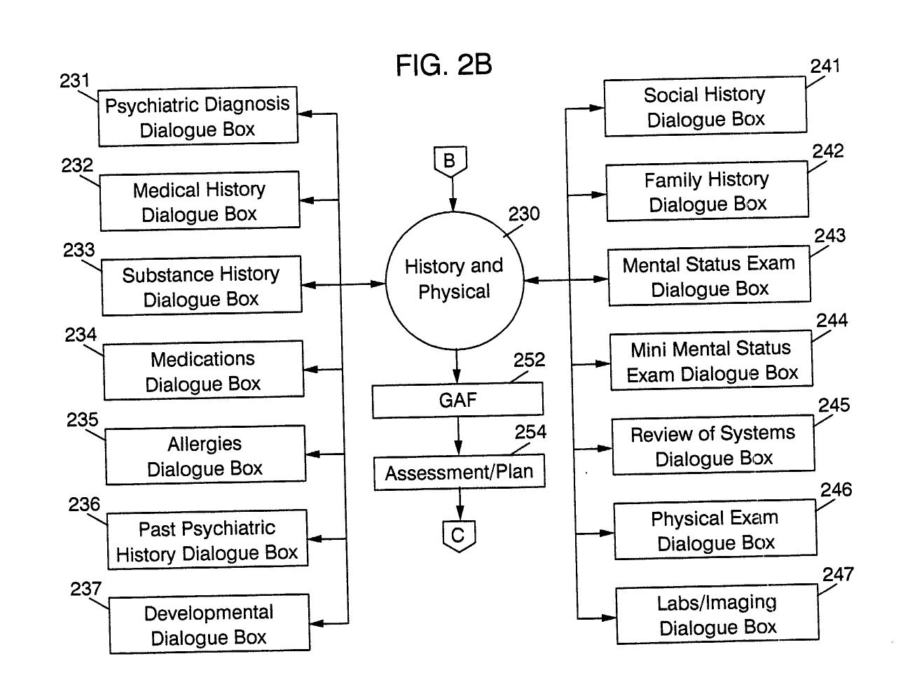

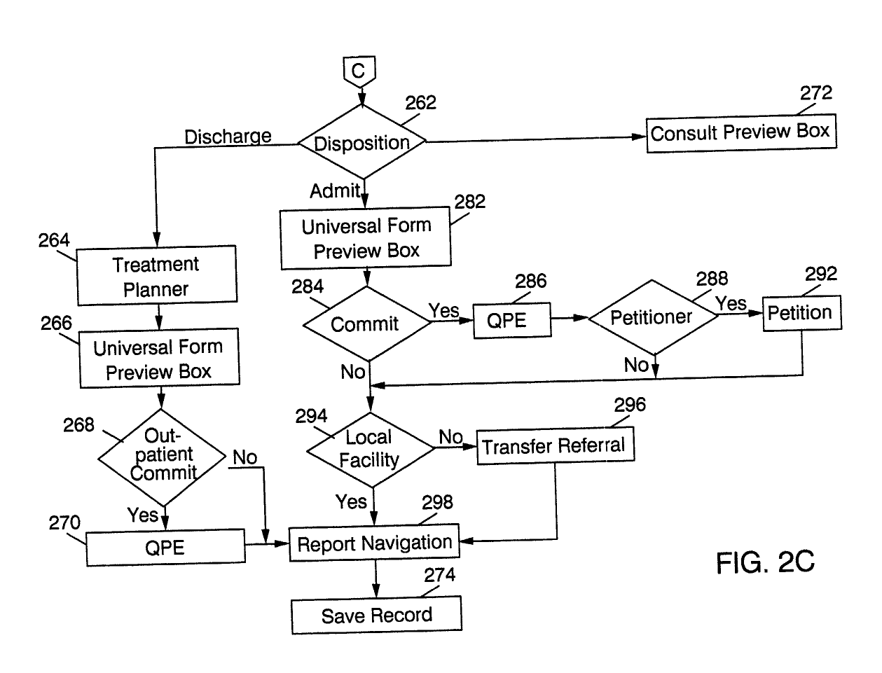

FIGS. 2A-2C, which when placed together as indicated form FIG. 2, illustrate psychiatric information systems, methods and computer program products according to other embodiments of the invention that can be used in an emergency room setting to provide, for example, the emergency room module 110 of FIG. 1. Similar embodiments can be used in a clinical, research or other settings.

As shown in FIG. 2A, in order to enter or retrieve data concerning a patient, the patient may need to be identified. Accordingly, operations can begin by accessing a log-on page at Block 202, and upon successful log-on, accessing a main menu at Block 204. A search page may be accessed from the main menu at Block 206, and a search for a patient may be performed at Block 208. As shown at Block 208, the search may be performed of a psychiatric database and/or a Medical Center (MC) database. At Block 212, if multiple patients are found, then a multiple patient dialogue box is presented at Block 214, and a correct patient is chosen. If multiple patients are not found, then at Block 216, if a new entry is being made, then a demographic dialogue box is opened at Block 218. If a new entry is not desired to be entered at Block 216, then a non-editable patient record is accessed at Block 222. If a new entry for the patient is desired to be entered at Block 224, the demographic dialogue box 218 is accessed again so that the new entry can be added. If not, then the search page is again accessed at Block 206. Accordingly, a patient may be identified and demographic data may be entered.

The emergency room module 110, outpatient module 120, scales module 130, research module 150 and treatment plan module 170 of FIG. 1 each may include the dialogue boxes shown in FIG. 2B. The dialogue boxes all interact with a database repository 230, labeled as “history and physical” in FIG. 2B, which may be the same as the database repository 180 of FIG. 1. As is well known to those having skill in the art, a dialogue box is a computer display window that contains a form or checklist for the user to fill out. These forms can include text boxes, regular list boxes, drop-down list boxes, check boxes and/or sliding controls. See, for example, Windows 95 for Dummies, Second Edition, by Rathbone, IBG Books Worldwide Inc., 1997.

As shown in FIG. 2B, the following dialogue boxes may be included: a psychiatric diagnosis dialogue box 231, a medical history dialogue box 232, a substance history dialogue box 233, a medications dialogue box 234, an allergies dialogue box 235, a past psychiatric history dialogue box 236, a developmental dialogue box 237, a social history dialogue box 241, a family history dialogue box 242, a mental status exam dialogue box 243, a mini mental status exam dialogue box 244, a review of systems dialogue box 245, a physical exam dialogue box 246, and a labs/imaging dialogue box 247. Each of these dialogue boxes 231-247 interfaces with the database repository 230, to store discrete data elements that are captured by each of these dialogue boxes.

In particular, the psychiatric diagnosis dialogue box 231 is configured to capture psychiatric diagnoses of psychiatric patients, as discrete data elements. The medical history dialogue box 232 is configured to capture non-psychiatric medical histories of psychiatric patients, as discrete data elements. The substance history dialogue box 233 is configured to capture histories of substance use by psychiatric patients, as discrete data elements. The medications dialogue box 234 is configured to capture information concerning medications used by psychiatric patients, as discrete data elements. The allergies dialogue box 235 is configured to capture information concerning allergies of psychiatric patients, as discrete data elements. The past psychiatric history dialogue box 236 is configured to capture past psychiatric histories of psychiatric patients, as discrete data elements. The developmental dialogue box 237 is configured to capture information concerning stages of development of psychiatric patients, as discrete data elements.

Moreover, the social history dialogue box 241 is configured to capture social histories of psychiatric patients, as discrete data elements. The family history dialogue box 242 is configured to capture information concerning family histories of psychiatric patients, as discrete data elements. The mental status exam dialogue box 243 is configured to capture results of standardized mental status tests of psychiatric patients, as discrete data elements. The mini mental status exam dialogue box 244 is configured to capture the results of short standardized mental status tests of psychiatric patients, as discrete data elements. The review of systems dialogue box 245 is configured to capture patient mental health complaints, as discrete data elements. The physical exam dialogue box 246 is configured to capture information concerning physical exams of psychiatric patients, as discrete data elements. Finally, the labs/imaging dialogue box 247 is configured to capture results of laboratory tests and/or medical imaging tests of psychiatric patients, as discrete data elements.

Accordingly, embodiments of the invention as shown in FIG. 2B can be used in a clinical environment, such as in an emergency room module 110 and/or in an outpatient module 120 of FIG. 1, and can offer psychiatrists a rich working environment that is based on a clinical service line model. A clinical service line can gather information from a psychiatric patient at every clinical contact. For example, at an initial visit, a receptionist can gather demographic data. A nurse can gather clinically significant data like allergies, adverse reactions and medication lists, for example using the allergies dialogue box 235 and the medications dialogue box 234. The psychiatrist can complete the medical record by entering a diagnosis using the psychiatric diagnosis dialogue box 231. All of the data gathered at the various patient encounters can be automatically combined in the database repository 230, to allow a complete and dynamic medical record to be created efficiently. This can reduce and preferably eliminate redundant data collection, and also can allow improvement in the clinical experience for the patient. Moreover, data that is collected in one environment, for example by the emergency room module 110 of FIG. 1, also is available and accessible in other environments, such as in the outpatient module 120 of FIG. 1, so that redundant information need not be entered and a complete picture of a patient's physical and mental health can be viewed. Finally, a longitudinal view of a patient's physical and mental health can be viewed so that the patient may be asked focused questions, thereby improving patient satisfaction with the clinical experience.

An electronic medical record, a clinical summary and a treatment timeline can be produced for each psychiatric patient. The electronic medical record can include the following information that may be collected at each clinical encounter: history of the present psychiatric illness (psychiatric diagnosis dialogue box 231), past psychiatric history (past psychiatric history dialogue box 236), medical history (medical history dialogue box 232), substance-related history (substance history dialogue box 233), medications list (medications dialogue box 234), allergies list (allergies dialogue box 235), social history (social history dialogue box 241), family psychiatric history (family history dialogue box 242), review of systems (review of systems dialogue box 245), physical exam (physical exam dialogue box 246), laboratory values, ECG imaging and imaging data (lab/imaging dialogue box 247), and mental status exams (mental status exam dialogue box 243 and mini mental status exam dialogue box 244).

As also shown in FIG. 2B, psychiatric dialogue boxes and non-psychiatric medical dialogue boxes may be integrated in a single system and the information that is captured may be stored in a single database repository 230. Thus, information concerning medication side effects, lab values, medical history or allergies may be accessible to the psychiatrist, so that the psychiatrist can provide quality care. As was also described above, the dialogue boxes allow discrete data elements to be collected on every aspect of a patient's medical record, from social development and developmental history, to physical exams. Traditional text-based psychiatry thereby can be integrated with non-psychiatric medical information systems.

Moreover, the dialogue boxes 231-247 shown in FIG. 2B may also allow analogous free text entry and storage into the database 230, so that the stored data elements from the dialogue boxes 231-247 and free text may be combined to produce clinical reports instantly. For example, an initial evaluation with a history and physical, demographics, progress notes, medications list and a clinical summary may be produced, which includes discrete data elements from at least some of the dialogue boxes 231-247 of FIG. 2B, along with accompanying free text. Thus, traditional free text-based psychiatry can be integrated with discrete data elements. Finally, the forms/reports function 190 can complete required standard paperwork using the discrete data elements that are entered as a result of the dialogue boxes 231-247. For example, duplicate copies of state petition forms for involuntary commitment can be automatically completed using previously entered data elements.

Still referring to FIG. 2B, a Global Assessment of Functioning (GAF) may be obtained from the database repository 230 or generated by the psychiatrist at Block 252. The GAF may be used to formulate an assessment plan 254 for the patient.

Referring now to FIG. 2C, having derived an assessment plan for the patient at Block 254 of FIG. 2B, various dispositions of the patient then may be handled at Block 262. As shown, if the disposition of the patient is to discharge the patient, then at Block 264, a treatment planner dialogue box may be accessed. A universal medical form preview dialog box may be accessed at Block 266, and if a decision is made to commit to outpatient at Block 268, the requisite government forms, such as an involuntary commitment (QPE) form, may be filled in at Block 270.

Returning to Block 262, if a decision is made to admit the psychiatric patient, then the universal form preview dialogue box may be accessed at Block 282, and if a decision is made to commit at Block 284, then the requisite government forms, such as the QPE form, may be filled in at Block 286. If the petitioner is not able to sign the form at Block 288, then a petition also may be generated at Block 292, for signature by the physician. If a decision is made not to commit the patient at Block 284, a decision is made at Block 294 as to whether a local facility is to be used for treatment. If no, then a transfer referral form is filled in at Block 296. If yes, then at Block 298, report navigation is performed by the system to determine the appropriate report that is used to effect the treatment at the local facility. Returning again to Block 262, if the disposition is for further consultation, a consult preview dialogue box 272 may be accessed. Accordingly, the dialogue boxes and other blocks of FIG. 2C can create a paper bridge for psychiatry by allowing paper intensive psychiatric forms and reports to be generated, using data that was input using the dialog boxes and other blocks of FIG. 2C. Finally, at Block 274, the record is saved in the repository 230.

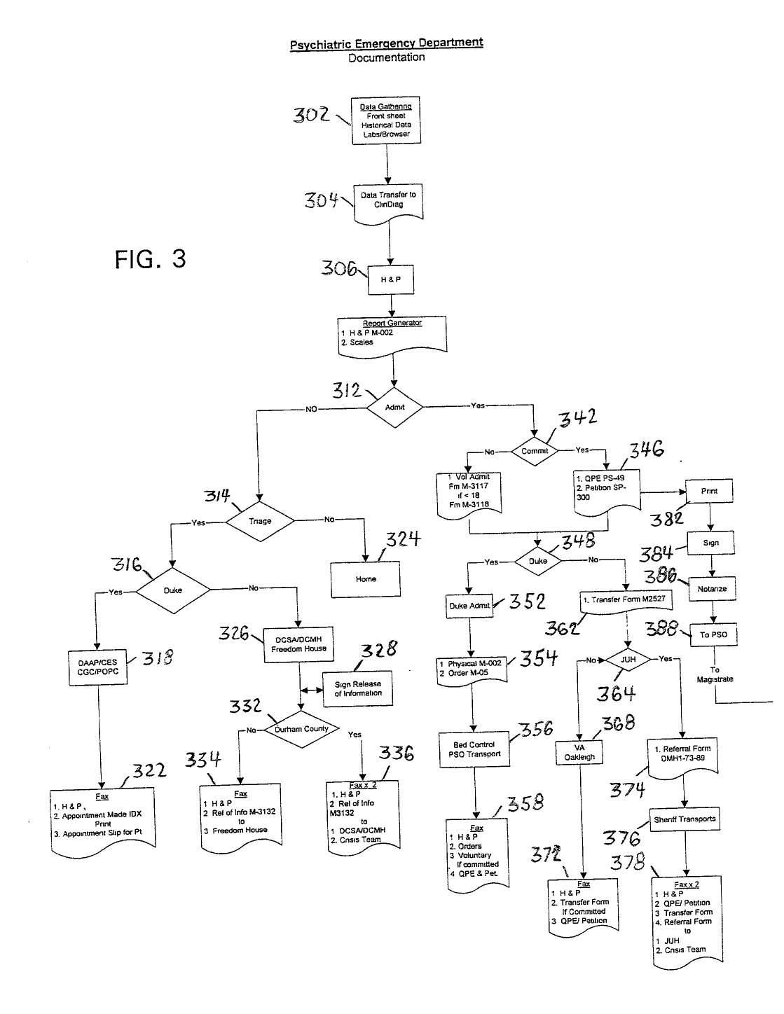

FIG. 3 is a flowchart illustrating the generation of reports, forms and other documentation for a psychiatric emergency room, such as may be provided by the emergency room module 110 of FIG. 1, according to embodiments of the present invention. FIG. 3 also illustrates interaction of an emergency room module with other modules, for example the modules of FIG. 1 and the dialogue boxes of FIG. 2B.

In particular, as shown at Block 302, initial data gathering is performed using, for example, the dialogue boxes of FIG. 2B. This data (Block 304) is input into the repository 230 (labeled H&P for history and physical) at Block 306, and the report generator 190 generates reports at Block 308. Thus, information concerning an emergency room psychiatric patient, including results of psychiatric tests and non-psychiatric medical tests, is stored in a database. A report is displayed of the information concerning the emergency room psychiatric patient, for review by a psychiatrist.

Still referring to FIG. 3, a decision is then accepted at Block 312 as to whether or not to admit the patient. If a decision is made not to admit the patient, then at Block 314, triage is performed by accepting a decision for home treatment 324 or for treatment at a local hospital, here indicated as “Duke” at Block 316. If to the local hospital, then various forms are automatically generated at Block 318 and an appointment slip may be faxed to the hospital at Block 322. If another associated local hospital at Block 326, a release may be printed at Block 328, if necessary, and the appropriate forms (Blocks 334 and 336) may be provided to the various facilities as a result of a decision at Block 332 to select a local facility. Thus, selection of whether to commit the psychiatric patient or to treat the psychiatric patient on an outpatient basis is accepted. Forms for committing the psychiatric patient or for treating the psychiatric on an outpatient basis may be automatically generated in response to the selection.

Referring again to Block 312, if a decision is made to admit and a decision is made to commit at Block 342, the requisite forms can be generated at Block 346, printed at Block 382, signed at Block 384, notarized at Block 386 and sent to the Provider Sponsored Organization (PSO) at Block 388 and to a magistrate if necessary. On the other hand, if a decision is made not to commit, then various forms are generated at Block 344. If a decision is made at Block 348 to admit to the local hospital, then processing is performed at Block 352 to admit, forms are generated at Block 354, transport is arranged at Block 356, and a fax is sent at Block 358. If the commitment is not to the local hospital at Block 348, then a transfer form is generated, a decision is made as to which non-local hospital is used at Block 364, and processing is provided to a first local hospital at Block 368 along with appropriate forms at Block 372. Alternatively, forms are generated/faxed at Blocks 374 and 378, and appropriate transport is arranged at Block 376.

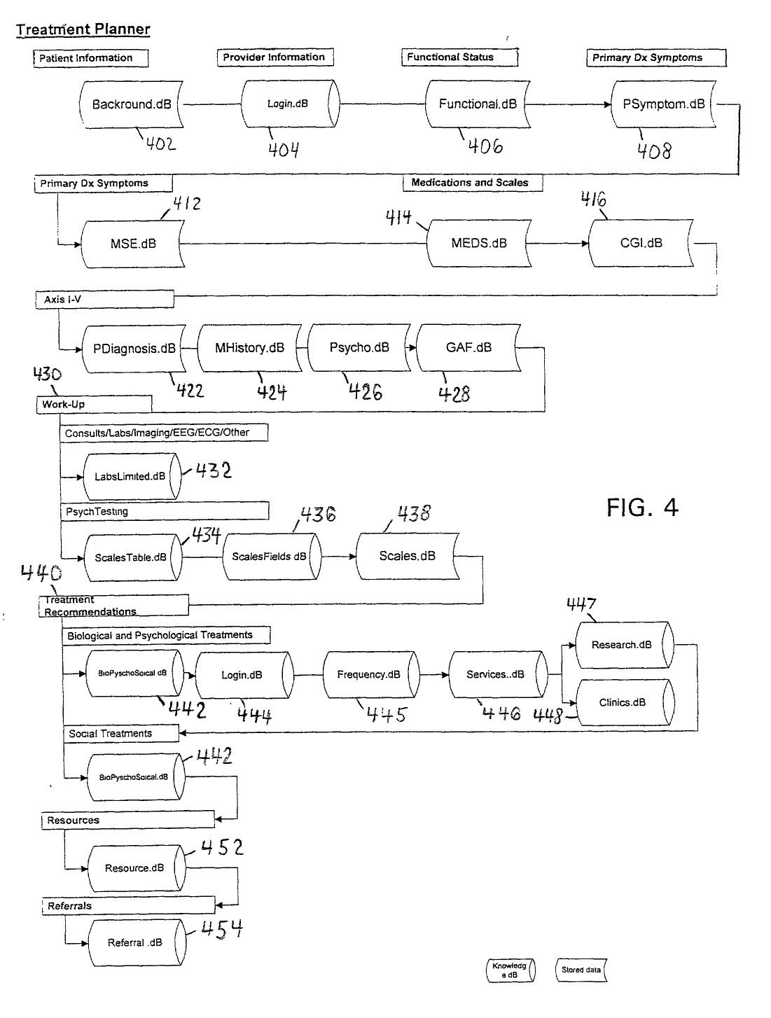

FIG. 4 is a flowchart illustrating psychiatrist and database interaction to produce a treatment plan for a psychiatric patient, for example using the treatment plan module 170 of FIG. 1. In general, information concerning symptoms, medications, psychological tests, psychological history and medical history of the psychiatric patient is stored in a database. At least some of the stored information is displayed, and a treatment recommendation for the psychiatric patient is accepted in response to the display. The treatment recommendation for the psychiatric patient is stored in a database. A treatment plan for the psychiatric patient is automatically generated from the stored information from the stored treatment recommendation.

More specifically, as shown in FIG. 4 at Block 402, a background database is populated with stored data that may be obtained, for example using dialogue boxes 231-247 of FIG. 2B. Provider information is obtained from a log-in knowledge database 404 and functional status is obtained from a functional database 406. Primary diagnosis symptoms are obtained from a primary symptom database at Block 408. Medications and scales are obtained, for example from the dialog boxes 231-247 of FIG. 2B, and the primary doctor symptoms then can be used to populate a Mental Status Exam (MSE) database 412, a MEDS database 414 and a CGI database 416. Test results from the psychiatric diagnosis dialogue box 231 also may be stored in a PDiagnosis database 422. Results from the medical history dialogue box 232 may be stored in the MHistory database 424. Past psychiatric history may be stored in the Psycho database 426 and functional results may be stored in the GAF database 428. A work-up is then provided to the psychiatrist at Block 430, wherein the psychiatrist can order the lab and imaging data to be obtained in a LabsLimited database 432 and can order psychological testing in Scales databases 434, 436 and 438. Treatment recommendations are then made by the psychiatrist at Block 440. These can include biological and psychological services and frequencies that are stored in databases 442, 444, 445 and 446, and that also may be provided to a research database 447 and a clinics database 448, depending on the services. Social treatments that are stored in the database 442 also may be ordered. Resources also may be committed and stored in the resources database 452 and referrals may be made using the referrals database 454. Accordingly, as shown in FIG. 4, data elements that are stored in a database repository may be used by a psychiatrist to work up a treatment plan, and to automatically generate treatment recommendations and commit resources for the treatment recommendations.

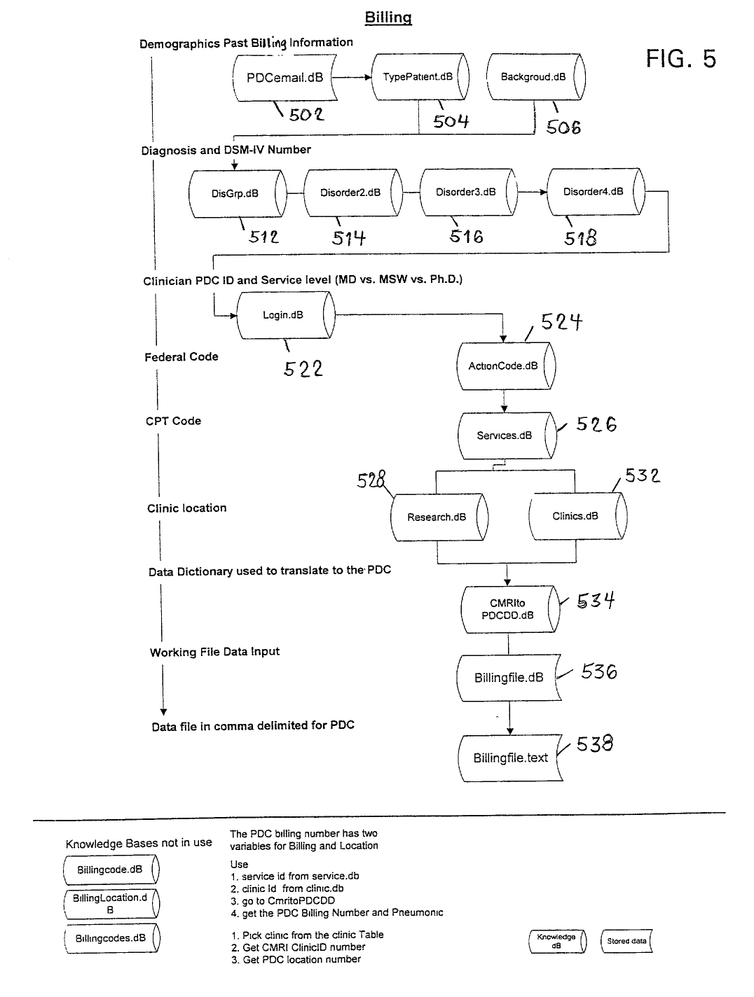

Finally, FIG. 5 is a flowchart of interactions among psychiatrists, other personnel and databases to produce billings, for psychiatric treatment using a billing module, for example the billing module 160 of FIG. 1. These embodiments of the invention can store a diagnosis of the psychiatric patient in a database, store identifications of providers of psychiatric services in a database and automatically generate a bill for the psychiatric treatment of the psychiatric patient from the diagnosis that is stored and the identifications that are stored.

Referring now to FIG. 5, demographics and past billing information is imported into the system, for example using a private billing database 502 to populate patient and background database 504 and 506. A diagnosis then is obtained from the databases 512, 514, 516, 518. Bills then are created using a Login database 522 that identifies providers of psychiatric treatments (psychiatrists, social workers and/or Ph.D.'s). The appropriate federal codes then are obtained from a database at Block 524, and a billing code is obtained from database 526 for the services that were performed. Based on the location of the services as provided by databases 528 and 532, the services are translated into billing information in database 534 and a billing file is created in database 536. A bill is generated as text in database 538. Accordingly, billing can be performed automatically using information gathered from multiple databases.

Embodiments of the present invention also can create efficiencies in management of psychiatric care. Efficiencies can come from improved processes of treatment and/or research and improved quality of treatment and/or research. In particular, the process of research and treatment can be automated using the report generator, the form duplicator and direct data entry. Continuous quality improvement also may be applied to research by taking advantage of information technology networks. Network information processing and centralized data collection can improve quality by adding responsiveness to problems and the flexibility of modification. The ability to monitor sites and data collection with online data analysis can facilitate the recognition of problems and the need for modifications quickly. Networking can offer the flexibility to implement these changes within hours, as opposed to days or weeks. Changes can be implemented and new versions can be distributed instantaneously to all sites.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A psychiatric information system comprising:
an emergency room module that is configured to capture psychiatric information concerning emergency room visits by psychiatric patients, including psychiatric assessments, as discrete data elements;
an outpatient module that is configured to capture psychiatric information concerning outpatient visits by psychiatric patients, including psychiatric assessments, as discrete data elements;
a scales module that is configured to capture direct data entry of psychiatric scales as discrete data elements; and
a database repository that is configured to store the discrete data elements that are captured by the emergency room module, the outpatient module and the scales module.

2. A psychiatric information system according to claim 1 further comprising:
a query module that is configured to initiate queries of the discrete data elements that are captured by the emergency room module, the outpatient module and the scales module that are stored in the database repository.

3. A psychiatric information system according to claim 1 further comprising:
a data mining module that is configured to perform data mining of the discrete data elements that are captured by the emergency room module, the outpatient module and the scales module that are stored in the database repository, to produce data mining results that are free of personal identifying information on the psychiatric patients.

4. A psychiatric information system according to claim 1 further comprising:
a research module that is configured to capture psychiatric information concerning individuals who are participating in a psychiatric research study, as discrete data elements, the database repository being further configured to store the discrete data elements that are captured by the research module.

5. A psychiatric information system according to claim 1 further comprising:
a billing module that is configured to generate medical bills from the discrete data elements that are captured by the emergency room module, the outpatient module and the scales module that are stored in the database repository.

6. A psychiatric information system according to claim 5 wherein the billing module is further configured to complete government and insurance forms from the discrete data elements that are captured by the emergency room module, the outpatient module and the scales module that are stored in the database repository.

7. A psychiatric information system according to claim 1 further comprising:
a treatment plan module that is configured to capture a treatment plan for individuals who are undergoing psychiatric treatment, as discrete data elements, the database repository being further configured to store the discrete data elements that are captured by the treatment plan module.

8. A psychiatric information system according to claim 1:
wherein the emergency room module is configured to capture psychiatric information concerning emergency room visits by psychiatric patients, including psychiatric assessments, as discrete data elements, using at least one dialogue box;
wherein the outpatient module is configured to capture psychiatric information concerning outpatient visits by psychiatric patients, including psychiatric assessments, as discrete data elements, using at least one dialogue box; and
wherein the scales module is configured to capture direct data entry of psychiatric scales as discrete data elements, using at least one dialogue box.

9. A psychiatric information system comprising:
a psychiatric diagnosis dialogue box that is configured to capture psychiatric diagnoses of psychiatric patients, as discrete data elements;
a past psychiatric history dialogue box that is configured to capture past psychiatric histories of psychiatric patients, as discrete data elements;
a social history dialogue box that is configured to capture social histories of psychiatric patients, as discrete data elements;
a mental status exam dialogue box that is configured to capture results of standardized mental status tests of psychiatric patients, as discrete data elements; and
a database repository that is configured to store the discrete data elements that are captured by the psychiatric diagnosis dialogue box, the past psychiatric history dialogue box, the social history dialogue box and the mental status exam dialogue box.

10. A psychiatric information system according to claim 9 further comprising:
a medical history dialogue box that is configured to capture non-psychiatric medical histories of psychiatric patients, as discrete data elements;
the database repository being further configured to store the discrete data elements that are captured by the medical history dialogue box.

11. A psychiatric information system according to claim 9 after comprising:
a substance history dialogue box that is configured to capture histories of substance use by psychiatric patients, as discrete data elements;
the database repository being further configured to store the discrete data elements that are captured by the substance history dialogue box.

12. A psychiatric information system according to claim 9 further comprising:
a medications dialogue box that is configured to capture information concerning medications used by psychiatric patients, as discrete data elements;
the database repository being further configured to store the discrete data elements that are captured by the medications dialogue box.

13. A psychiatric information system according to claim 9 further comprising:
an allergies dialogue box that is configured to capture information concerning allergies of psychiatric patients, as discrete data elements;
the database repository being further configured to store the discrete data elements that are captured by the allergies dialogue box.

14. A psychiatric information system according to claim 9 further comprising:
a developmental dialogue box that is configured to capture information concerning stages of development of psychiatric patients, as discrete data elements;
the database repository being further configured to store the discrete data elements that are captured by the developmental dialogue box.

15. A psychiatric information system according to claim 9 further comprising:
a family history dialogue box that is configured to capture information concerning family histories of psychiatric patients, as discrete data elements;
the database repository being further configured to store the discrete data elements that are captured by the family history dialogue box.

16. A psychiatric information system according to claim 9 further comprising:
a physical exam dialogue box that is configured to capture information concerning physical exams of psychiatric patients, as discrete data elements;
the database repository being further configured to store the discrete data elements that are captured by the physical exam dialogue box.

17. A psychiatric information system according to claim 9 further comprising:
a labs/imaging dialogue box that is configured to capture results of laboratory tests and medical imaging tests of psychiatric patients, as discrete data elements;
the database repository being further configured to store the discrete data elements that are captured by the labs/imaging dialogue box.

18. A psychiatric information system according to claim 9 further comprising:
a query module that is configured to initiate queries of the discrete data elements that are captured by the psychiatric diagnosis dialogue box, the past psychiatric history dialogue box, the social history dialogue box and the mental status exam dialogue box that are stored in the database repository.

19. A psychiatric information system according to claim 9 further comprising:
a data mining module that is configured to perform data mining of the discrete data elements that are captured by the psychiatric diagnosis dialogue box, the past psychiatric history dialogue box, the social history dialogue box and the mental status exam dialogue box that are stored in the database repository, to produce data mining results that are free of personal identifying information on the psychiatric patients.

20. A psychiatric information system according to claim 9 further comprising:
a billing module that is configured to generate medical bills from the discrete data elements that are captured by the psychiatric diagnosis dialogue box, the past psychiatric history dialogue box, the social history dialogue box and the mental status exam dialogue box that are stored in the database repository.

21. A psychiatric information system according to claim 20 wherein the billing module is further configured to complete government and insurance forms from the discrete data elements that are captured by the psychiatric diagnosis dialogue box, the past psychiatric history dialogue box, the social history dialogue box and the mental status exam dialogue box that are stored in the database repository.

22. A psychiatric information system according to claim 9 further comprising:
an assessment plan module that is configured to generate an assessment plan for individuals who are undergoing psychiatric treatment, from the discrete data elements that are captured by the psychiatric diagnosis dialogue box, the past psychiatric history dialogue box, the social history dialogue box and the mental status exam dialogue box that are stored in the database repository.

23. A psychiatric information system according to claim 22 further comprising:
a forms module that is configured to complete government and insurance billing forms from the form the assessment plan.

24. A psychiatric information system comprising:
a psychiatric information module that is configured to capture psychiatric information concerning psychiatric patients, including psychiatric assessments, as discrete data elements; and
a database repository that is configured to store the discrete data elements that are captured by the psychiatric information module.

25. A psychiatric information system according to claim 24 further comprising:
a non-psychiatric medical information module that is configured to capture non-psychiatric medical information concerning psychiatric patients as discrete data elements, the database repository being further configured to store the discrete data elements that are captured by the non-psychiatric medical information module.

26. A psychiatric information system according to claim 25 further comprising:
a query module that is configured to initiate queries of the discrete data elements that are captured by the psychiatric information module and the nonpsychiatric medical information module that are stored in the database repository.

27. A psychiatric information system according to claim 25 further comprising:
a data mining module that is configured to perform data mining of the discrete data elements that are captured by the psychiatric information module and the nonpsychiatric medical information module, to produce data mining results that are free of personal identifying information on the psychiatric patients.

28. A psychiatric information system according to claim 24 further comprising:
a billing module that is configured to generate medical bills from the discrete data elements that are captured by the psychiatric information module and the non-psychiatric medical information module that are stored in the database repository.

29. A psychiatric information system according to claim 28 wherein the billing module is further configured to complete government and insurance forms from the discrete data elements that are captured by the psychiatric information module and the non-psychiatric medical information module that are stored in the database repository.

30. A psychiatric information method comprising:
capturing psychiatric information concerning emergency room visits by psychiatric patients, including psychiatric assessments, as discrete data elements;
capturing psychiatric information concerning outpatient visits by psychiatric patients, including psychiatric assessments, as discrete data elements;
capturing direct data entry of psychiatric scales as discrete data elements; and
storing the discrete data elements that are captured by the emergency room module, the outpatient module and the scales module in a database repository.

31. A psychiatric information method comprising:
capturing psychiatric diagnoses of psychiatric patients as discrete data elements in a psychiatric diagnosis dialogue box;
capturing past psychiatric histories of psychiatric patients as discrete data elements in a past psychiatric history dialogue box;
capturing social histories of psychiatric patients as discrete data elements in a social history dialogue box;
capturing results of standardized mental status tests of psychiatric patients as discrete data elements in a mental status exam dialogue box; and
storing the discrete data elements that are captured by the psychiatric diagnosis dialogue box, the past psychiatric history dialogue box, the social history dialogue box and the mental status exam dialogue box in a database repository.

32. A psychiatric information method comprising:
capturing psychiatric information concerning psychiatric patients, including psychiatric assessments, as discrete data elements; and
storing the discrete data elements that represent the psychiatric information in a database repository.

33. A method according to claim 32 further comprising:
capturing non-psychiatric medical information concerning psychiatric patients as discrete data elements; and
storing the discrete data elements representing the non-psychiatric medical information in the database repository.

34. A computer program product for psychiatric information, the computer program product comprising a computer usable storage medium having computer-readable program code embodied in the medium, the computer-readable program code comprising:
computer-readable program code that is configured to capture psychiatric information concerning emergency room visits by psychiatric patients, including psychiatric assessments, as discrete data elements;
computer-readable program code that is configured to capture psychiatric information concerning outpatient visits by psychiatric patients, including psychiatric assessments, as discrete data elements;
computer-readable program code that is configured to capture direct data entry of psychiatric scales as discrete data elements; and
computer-readable program code that is configured to store the discrete data elements in a database repository.

35. A computer program product for psychiatric information, the computer program product comprising a computer usable storage medium having computer-readable program code embodied in the medium, the computer-readable program code comprising:
computer-readable program code that is configured to capture psychiatric diagnoses of psychiatric patients as discrete data elements in a psychiatric diagnosis dialogue box;
computer-readable program code that is configured to capture past psychiatric histories of psychiatric patients as discrete data elements in a past psychiatric history dialogue box;
computer-readable program code that is configured to capture social histories of psychiatric patients as discrete data elements in a social history dialogue box;
computer-readable program code that is configured to capture results of standardized mental status tests of psychiatric patients as discrete data elements in a metal status exam dialogue box; and
computer-readable program code that is configured to store the discrete data elements that are captured by the psychiatric diagnosis dialogue box, the past psychiatric history dialogue box, the social history dialogue box and the mental status exam dialogue box in a database repository.

36. A computer program product for psychiatric information, the computer program product comprising a computer usable storage medium having computer-readable program code embodied in the medium, the computer-readable program code comprising:
computer-readable program code that is configured to capture psychiatric information concerning psychiatric patients, including psychiatrist assessments, as discrete data elements; and
computer-readable program code that is configured to store the discrete data elements that are captured in a database repository.

37. A psychiatric information method comprising:
storing information concerning an emergency room psychiatric patient, including results of psychiatric tests and non-psychiatric medical tests, in a database;
displaying a report of the information concerning the emergency room psychiatric patient, including the results of the psychiatric tests and the nonpsychiatric medical tests, for review by a psychiatrist;
accepting selection of whether to commit the psychiatric patient or to treat the psychiatric patient on an outpatient basis; and
automatically generating forms for committing the psychiatric patient or for treating the psychiatric patient on an outpatient basis in response to the selection.

38. A method according to claim 37 wherein the automatically generating comprises:
automatically generating hospital admittance forms for the psychiatric patient in response to the selection to commit the psychiatric patient; and
automatically generating outpatient appointment forms for the psychiatric patient in response to the selection to treat the patient on an outpatient basis.

39. A psychiatric information method comprising:
storing information concerning symptoms, medications, psychological tests, psychological history and medical history of a psychiatric patient in a database;
displaying at least some of the stored information concerning symptoms, medications, psychiatric tests, psychiatric history and medical history of the psychiatric patient;
accepting a treatment recommendation for the psychiatric patient in response to the displaying;
storing the treatment recommendations for the psychiatric patient in a database; and
automatically generating a treatment plan for the psychiatric patient from the stored information and from the stored treatment recommendation.

40. A psychiatric information method comprising:
storing a diagnosis of a psychiatric patient in a database;
storing identifications of providers of psychiatric services in a database; and
automatically generating a bill for psychiatric treatment of the psychiatric patient from the diagnosis that is stored and the identifications that are stored.
